(19) United States
(12) Patent Application Publication
(10) Pub. No.: US 2006/0038047 A1
(43) Pub. Date: Feb. 23, 2006

(54) INTERLOCK DEVICE FOR A BATCH FEED WASTE DISPOSER

(75) Inventors: Scott W. Anderson, Racine, WI (US); Steve P. Hanson, Racine, WI (US); Randall E. Hammer, Racine, WI (US)

Correspondence Address: LOCKE LIDDELL & SAPP LLP;ATTN. DOCKETING, 600 TRAVIS #3400, HOUSTON, TX, 77002, US

(73) Assignee: EMERSON ELECTRIC CO., St. Louis, MO (US)

(21) Appl. No.: 11/163,890

(22) Filed: Nov. 3, 2005

Related U.S. Application Data
(63) Continuation-in-part of application No. 10/389,142, filed on Mar. 14, 2003.

(51) Int. Cl. B02C 23/36

(52) U.S. Cl. 241/46.013

(57) ABSTRACT

A combination interlock and stopper device for a food waste disposer includes a first end receivable in a drain opening to plug the drain opening with a first handle attached thereto. Stopping members are attached to the first end that have at least a portion thereof extending beyond the outer periphery of the first end for engaging a ledge of the drain opening. The device further includes a second end opposite the first end, with a magnet attached to the second end to selectively actuate the food waste disposer when the second end is inserted into the drain opening. A second handle is attached to the second end.

### CROSS-REFERENCE TO RELATED APPLICATIONS

This application is a continuation-in-part of U.S. patent application Ser. No. 10/389,142, filed on Mar. 14, 2003, and is related to U.S. patent application Ser. No. 10/389,160 entitled “Switching Mechanism for a Batch Feed Waste Disposer,” also filed on Mar. 14, 2003, both of which are incorporated by reference.

### BACKGROUND

This disclosure is directed to food waste disposers, and more specifically to means to operate food waste disposers in a batch feed mode.

As opposed to continuous feed waste disposers, batch feed waste disposers operate by filling the disposer with waste food, then substantially blocking the drain opening prior to operating the disposer, thereby disposing of food waste in batches. A batch feed disposer uses an interlock device positioned in the drain opening to activate the disposer. The interlock device also prevents foreign objects, such as silverware, from entering the disposer during operation, but will typically allow water to flow into the disposer. Batch feed waste disposers are also used in kitchens that do not have an electrically wired switch above the sink area, in which case the interlock device acts as the switch for the batch feed waste disposer.

One common means for activating the disposer is through mechanical contact of the interlock device with a switch in the throat of the disposer. However, such mechanical means of activating the disposer have been unreliable and subject to premature failure.

Newer methods for activating a batch feed waste disposer have included non-contact approaches, such as activation of a magnetic switch for example. In this approach, the interlock device contains a magnet which, when properly aligned within the drain opening, closes a magnetic switch that activates the disposer. The interlock device must be positioned such that its magnet is in the correct vertical and radial position within the drain opening to align with the magnetic switch.

An interlock device must also be capable of remaining in position throughout the operation of the disposer while allowing the free flow of water into the disposer. However, when the disposer is not in use, it is desirable that the homeowner be able to retain water in the sink using a stopper without activating the disposer, such as for dishwashing. Previous disposers with magnetic interlocks have used two different devices to perform these two different functions—an interlock device for activation of the disposer with water flow, and a stopper device for water retention without disposer activation. What is needed is a single device that can perform both functions, thereby reducing the number of accessory parts for the disposer and sink and simplifying their use.

The present application addresses shortcomings associated with the prior art.

### SUMMARY

In accordance with certain teaching of the present disclosure, a combination interlock and stopper device for a food waste disposer includes a first end receivable in a drain opening to plug the drain opening with a first handle attached thereto. The first end defines stopping members extending beyond an outer periphery of the first end for engaging a ledge of the drain opening, preventing the device from being pushed through the drain opening when used to plug the drain opening. The device further includes a second end opposite the first end, with a magnet attached to the second end to selectively actuate the food waste disposer when the second end is inserted into the drain opening. A second handle is attached to the second end, and in certain embodiments, the second handle is removably attached.

The first handle is integrally formed with the first end in exemplary embodiments of the device. To attach the second handle to the second end, for example, the second handle defines projections extending from opposite ends thereof that are receivable by corresponding pockets defined in the second end of the device. Further, the pockets may be configured having first and second portions. The first portion receives the magnets that actuate the disposer, and the projections of the second handle are received by the second portions of the pockets to removably attach the second handle. The first end of the device defines a first effective diameter and the second end defines a second effective diameter larger than the first diameter. To allow fluid to flow through the second end, it defines openings therethrough.

### BRIEF DESCRIPTION OF THE DRAWINGS

Other objects and advantages of the invention will become apparent upon reading the following detailed description and upon reference to the drawings in which:

FIG. 1 shows a top view of a switching assembly in accordance with certain teachings of the present disclosure.

FIG. 2 shows a perspective view of a switching assembly snapped around a sink flange in accordance with certain teachings of the present disclosure.

FIG. 3 shows a perspective view of the switching assembly of FIG. 2 secured by a flange screw.

FIG. 4A shows a perspective view of the switching assembly including a plug for quick installation of the switching assembly.

FIG. 4B shows a schematic diagram of the plug of FIG. 4A.

FIG. 5A shows an exploded perspective view of an embodiment of an interlock device in accordance with certain teachings of the present disclosure.

FIG. 5B shows a cut-away of the lower disk of the interlock device depicted in FIG. 5A.

FIG. 6 shows a cross-sectional view of the interlock device depicted in FIG. 5A in the closed position.

FIG. 7 shows a cross-sectional view of the interlock device depicted in FIG. 5A in the open position.

FIG. 8 shows a perspective view of another embodiment of an interlock device in accordance with certain teachings of the present disclosure.

FIG. 9A shows a top view of the interlock device depicted in FIG. 8 in relation to a drain opening in the closed position.

FIG. 9B shows a top view of the interlock device depicted in FIG. 8 in relation to a drain opening in the open position.

FIG. 10 shows a side cross-sectional view of the interlock device depicted in FIG. 8 in relation to a drain opening in the open position.

FIG. 11 shows a side cross-sectional view of the interlock device depicted in FIG. 8 in relation to a drain opening in the closed position.

FIG. 12 shows a top perspective view of a further embodiment of an interlock device in accordance with certain teachings of the present disclosure.

FIG. 13 shows an exploded view of the interlock device depicted in FIG. 12.

FIG. 14 shows a bottom perspective view of the interlock device depicted in FIGS. 12 and 13.

FIG. 15 shows a perspective view of another embodiment of an interlock device having a removable handle.

FIG. 16 shows a side cross-sectional view of the interlock device depicted in FIG. 15.

FIG. 17 shows a side cross-sectional view of the interlock device depicted in FIGS. 15 and 16 in relation to a drain opening in the closed position.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Referring to FIGS. 1-4, a magnetic switching assembly 10 that attaches to a sink flange 20 is shown. A discussion of sink flanges as well as standard sink mounts for food waste disposers can be found in U.S. Pat. No. 3,025,007, which is incorporated by reference herein.

FIG. 1 depicts a top view of magnetic switch assembly 10, which consists of a housing 12, a magnet 14 (contained within the housing, shown in phantom), and a switch 16 (contained within the housing, shown in phantom) operatively coupled to magnet 14. Switch 16 ultimately connects to and controls the power supply (not shown) that operates the disposer through cable 18. Housing 12 is a one-piece housing made of a plastic material or any other suitable material. The term “one-piece housing” denotes the final structure of housing 12 as used by a homeowner, and it is envisioned that housing 12 may in fact be constructed of two or more pieces.

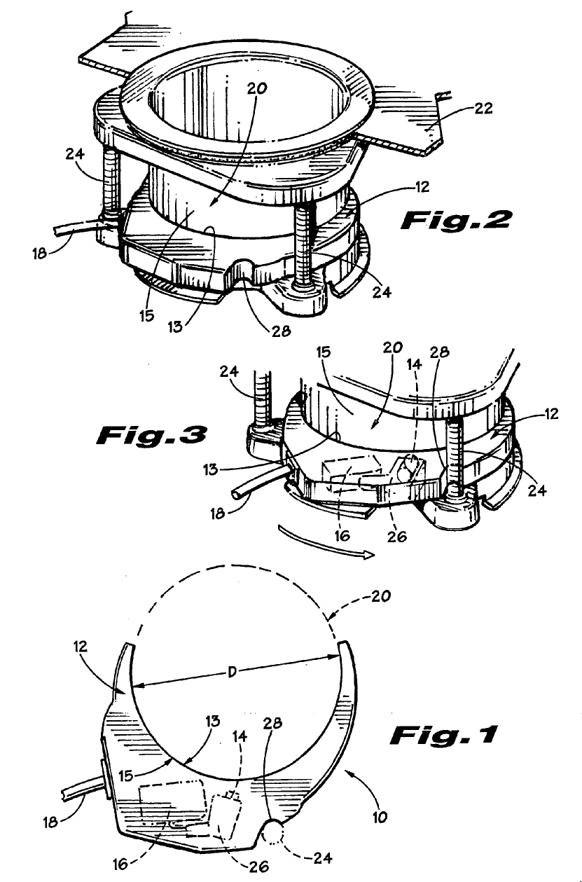

It is a preferred aspect of the present disclosure that housing 12 is attached to the sink flange 20 by “snapping” housing 12 around at least a portion of the exterior periphery of sink flange 20. It is also envisioned that housing 12 may be snapped onto any exterior surface 15 of the food waste disposer circumscribing the drain opening. As best shown in FIG. 1, this snapping engagement is accomplished by providing a housing 12 that matches the approximate diameter D of sink flange 20. In this manner, a first surface 13 of housing 12 engages the external surface 15 of sink flange 20 of the disposer. As best shown in FIG. 3, this first surface 13 and the external surface 15 are generally circular in geometry. Note also that it is preferred that housing 12 encompasses greater than half of the circumference of sink flange 20 so as to promote steady engagement of housing 12 to sink flange 20 while still allowing a snap fit. As best shown in FIG. 2, housing 12 snaps around sink flange 20 and remains fittingly engaged with sink flange 20 without requiring any disassembly of sink 22, sink flange 20, or the food waste disposer (not shown). In particular, housing 12 attaches to sink flange 20 in between two of the (typically) three flange screws 24. Thus, housing 12 can be installed or removed without removing any of the flange screws 24.

Housing 12 also preferably contains a locking groove 28 that is designed to engage at least one of the flange screws. Thus, magnetic switching assembly 10 can be securely installed by first snapping housing 12 around sink flange 20 (FIG. 2), then rotating housing 12 until locking groove 28 engages a flange screw 24. Securing the magnetic switching assembly 10 in this manner reduces the likelihood of the magnetic switching assembly 10 moving during operation of the food waste disposer and provides a consistent switching location.

One of skill in the art will realize that the proper position of housing 12 on sink flange 20 (i.e. the relative vertical distance below sink 22) is dependent upon the expected location of the activating magnet when the interlock device is positioned in the drain opening. Such a person skilled in the art will be able to adjust the position of the housing accordingly.

Housing 12 is designed to hold magnet 14, switch 16, and any other coupling devices 26 necessary to operatively couple magnet 14 to switch 16. Although FIGS. 1-4 illustrate housing 12 as completely containing magnet 14 and switch 16, it is feasible that the housing only partially contains one or both of these items. Although a single switch is depicted in the figures and described herein, one of skill in the art should appreciate that a plurality of switches may be used to provide a redundant switching system (e.g. a switching mechanism in which two switches must be closed in order to activate the food waste disposer). Another functional aspect of housing 12 is the steady positioning of magnet 14 at a location proximate to the exterior surface of sink flange 20. One of skill in the art will appreciate that this may be accomplished in several ways, one of which is depicted in FIG. 1 and FIG. 3.

As noted, switch 16 is designed to enable the operation of the food waste disposer upon sensing the presence of an interlock device having a magnet within the drain opening. Switch 16 is preferably a snap action switch coupled to a magnet 14, although it is envisioned that other types of receivers may be utilized for sensing the presence of the interlock device and its magnet. One skilled in the art should appreciate that the need for a separate magnet 14 within the switching assembly 10 is dependent upon the type of switch used. In the embodiments shown in FIGS. 1-3, a snap action switch 16 is used, and is coupled to magnet 14 as a means for sensing the interlock device's magnet and thereby closing the switch. However, the use of a reed switch or a Hall-Effect sensor as the receiver would not require a separate magnet in the housing. Inside a reed switch, two ferromagnetic contacts are either attracted or repelled in the presence of a magnetic field generated by the presence of a separate magnet, in this case the magnet located within an interlock device. The core of a Hall-Effect sensor is a Hall-Effect element. When a magnet is in the vicinity of the Hall-Effect element, a current flows within the element proportional to the strength of the field. The current produced in the element creates a potential difference between the two terminals. In a Hall-Effect switch, once this potential difference goes above a certain level, the switch then closes.

A snap action switch is preferred because it can handle the high running currents of a food waste disposer, which other types of switches may not be able to handle. Examples of snap action switches commonly found today on the market include the Cherry KWSA-0001 snap action switch and the Saia-Burgess snap action switch. Other switches, such as the reed switch or the Hall-Effect switch, may need to be used in combination with a relay or triac to allow high current operation. When the disposer is not in operation, switch 16 will be in the normally open configuration, meaning that the switch contacts are in the open-circuit position (i.e. the disposer is not activated).

There are two acceptable design alternatives for closing switch 16, both of which may be used to activate the food waste disposer. First, switch 16 may be closed when magnet 14 is “attracted” by another magnet located inside the sink flange 20. Second, switch 16 may be closed when magnet 14 is “repelled” by another magnet located inside the sink flange 20. As is known, the disclosed snap action switches contains buttons which when pressed will cause the switch to be closed. It may be necessary (depending on the type of snap action switch used) to couple the movement of magnet 14 in the housing to the button on the switch 16. Accordingly, a coupling means 26, which is specially fitted to receive magnet 14 and to interface with the switch's 16 button, is designed to move as the magnet 14 moves, and accordingly to close the switch. Coupling means 26 is in one embodiment a specially formed and shaped piece of hard plastic, but could be made from several different materials and in several different configurations to effectuate proper transfer of the magnet force to the switch 16. However, depending on the orientation of the magnet and the switch, a coupling means 26 may not be necessary, so long as the magnet's force can be imparted directly to the switch. Moreover, a combined magnet/switch assembly can be used in lieu of components 14, 16, and 26, in which case the magnet on the assembly operates as the switch and directly controls the switching function.

Magnet 14 is preferably a rare earth magnet, and more preferably a magnet comprised of neodymium, and even more preferably a magnet comprised of neodymium iron boron. Rare earth magnets are preferred because of their strength, small size, reliability, and cost. Testing also reveals that rare earth magnets provide a more robust and accurate switching location, which is important for ease of use by homeowners.

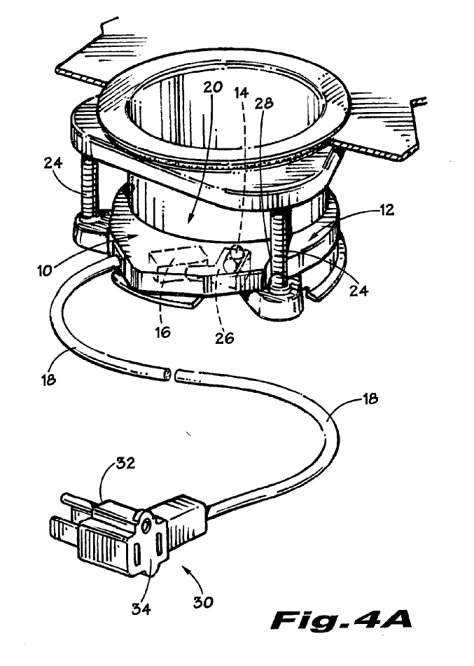

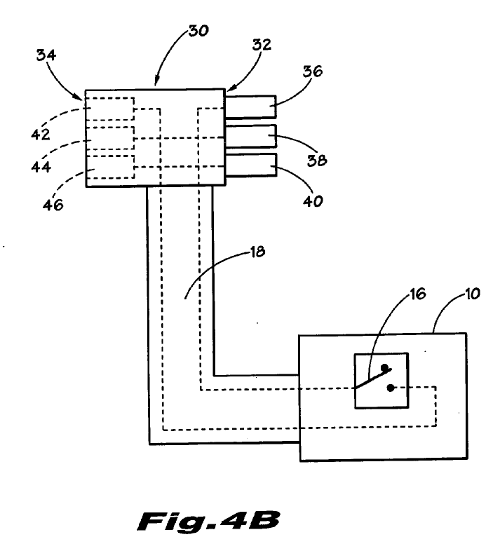

FIGS. 4A and 4B show an additional feature of the present disclosure. Although cable 18 may be connected directly to the food waste disposer, cable 18, may also be connected to plug 30 which may be plugged into a standard grounded electrical outlet. Plug 30 contains a male end 32 and a female end 34. As is well known in the art, male end 32 comprises three terminals, line terminal 36, neutral terminal 38, and ground terminal 40. Female end 34 has a line receptacle 42, a neutral receptacle 44, and a ground receptacle 46 for receiving a plug from a food waste disposer (not shown). As is shown in FIG. 4B, the food waste disposer can only be activated when the circuit connecting the line terminal 36 with line terminal 42 is closed by closing switch 16 of switching assembly 10. This design is especially useful for converting a continuous feed waste disposer into a batch feed waste disposer as it does not require any wiring on the part of the homeowner.

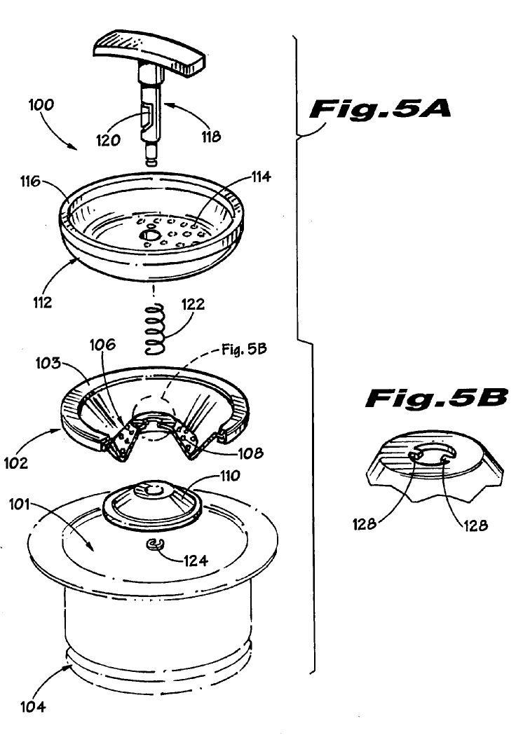

Turning now to FIGS. 5-7, a first embodiment of an interlock device 100 is shown in relation to drain opening 101. A lower disk 102 incorporates a seal 103 on the circumference of its upper edge for sealing with the strainer flange 104 of the food waste disposer. The lower disk 102 is designed with a conical section 106 having holes 108 that allow water flow when rubber seal 110 is in the open position. Rubber seal 110 is preferably a solid conical rubber part that mates with the conical section 106 of the lower disk 102 when in the closed position, thereby preventing water from flowing though the holes 108.

The interlock device 100 uses a movable strainer basket 112 that has drain holes 114 for the passage of water, and a magnet band 116 on the circumference of its upper edge. The strainer basket 112 is movable downward through a twist-and-lock motion of the stem 118. The track 120 on the stem 118 meets with tabs 128 (see FIG. 5B) located at the top of the conical section 106 to guide the twist and lock motion of the strainer basket 112 when moving from the closed to the open position and vice versa. A spring 122 fits over stem 118 between the strainer basket 112 and the lower disk 102, tending to bias the parts away from each other. Retaining ring 124 attaches to the bottom of stem 118 to secure the rubber seal 110 to stem 118. Alternatively, other retaining means may be employed, including but not limited to a retaining pin, adhesive means, threaded connection between stem 118 and rubber seal 110, or a pressing connection between stem 118 and rubber seal 110.

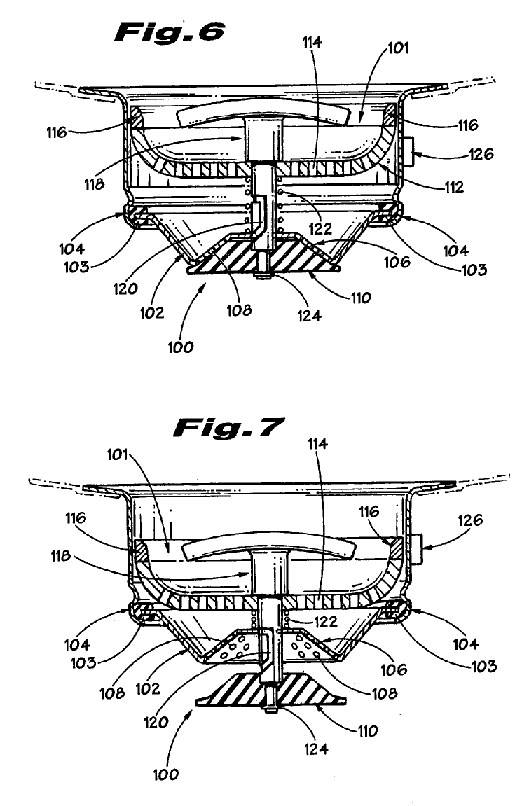

In FIG. 6 the interlock device 100 is shown in the closed position. In the closed position, rubber seal 110 is engaged with the conical section 106 of the lower disk 102. Also in the closed position, magnet band 116 is above the switching position necessary to close the switch 126 (i.e., switch 16 of FIGS. 1-4), and thus is unable to activate the food waste disposer. Accordingly, water can pass through holes 114 in the strainer basket 112, but is prevented from flowing through the holes 108 in lower disk 102 because of the engagement of rubber seal 110. Therefore, when closed, the interlock device 100 acts as a stopper for the sink without activating the batch food waste disposer.

In FIG. 7 the interlock device 100 is shown in the open position. Interlock device 100 is moved from the closed position to the open position by pushing downward on the spring loaded stem 118. Tabs 128 (FIG. 5B) on the lower disk 102 follow track 120 upward as stem 118 is pushed downward. When tabs 128 reach the top of track 118, the stem can then be turned to lock tabs 128 in the horizontal portion of track 120.

In this open position, magnet band 116 is aligned with switch 126, thereby closing switch 126 and activating the food waste disposer. Note that because magnet band 116 covers the circumference of strainer basket 112, radial alignment of the magnet band 116 with the switch 126 is not an issue with this embodiment. However, it is possible that magnet band 116 could be replaced with a smaller magnet located at one position along the upper edge of strainer basket 112. In this alternative embodiment, it would be necessary to radially align this smaller magnet with switch 126, which could constitute an important additional feature. In the open position, drain holes (108, 114) on both the lower disk 102 and the strainer basket 112 are open for water to drain into the disposer, which is desirable during the operation of the disposer.

Reversing the twisting motion described above, in conjunction with the bias of spring 122, returns strainer basket 112 and rubber seal 110 to the closed position, thereby deactivating the food waste disposer. As is evident, removing interlock device 100 from the drain opening would allow water flow through the drain opening without disposer activation.

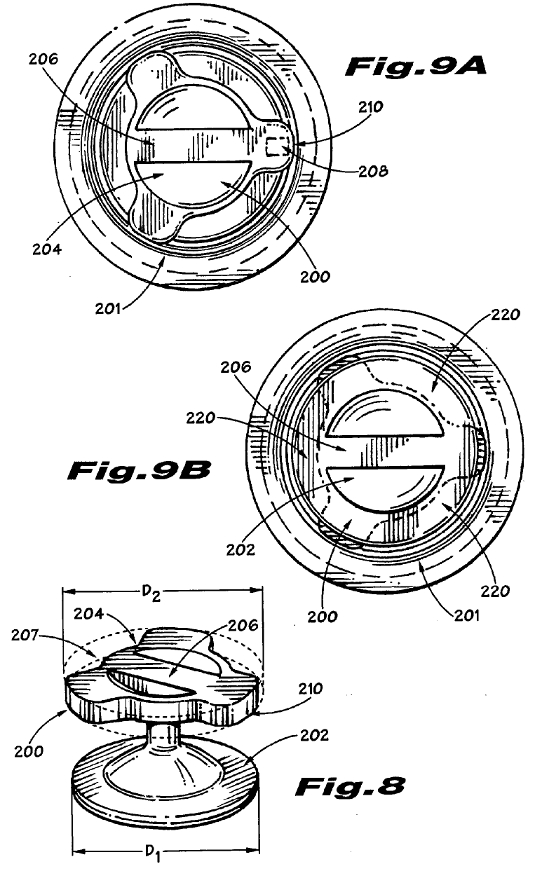

Turning now to FIGS. 8-11, a second embodiment of an interlock device 200 is shown in relation to drain opening 201. Interlock device 200 is preferably a one-piece unit having no movable components. The interlock device 200 has two opposing ends: a first end 202 having a diameter D₁ and a second end 204 having an effective diameter D₂, where D₂ is greater than D₁. The second end may be circular in shape, or may be non-circular as shown in FIGS. 8-11. In this regard, the “effective” diameter D₂ constitutes the diameter of a circle circumscribed about the non-circular second end 204. Each end provides a different functionality for stopper 200. In this embodiment, a magnet 208 is positioned at the outer periphery 210 of the second end 204. Orienting stopper 200 such that a particular end is placed into drain opening 201 dictates the operability of the food waste disposer. Additionally, each end (202, 204) may contain a handle 206 formed within that side to facilitate handling by the homeowner.

FIG. 9A and FIG. 11 show interlock device 200 in relation to drain opening 201 in the closed position. First end 202 is inserted downward into drain opening 201 and seats with the existing mounting gasket 212 (as shown in FIG. 11), such that a primary sealing surface 210 is formed, thereby blocking the flow of water through drain opening 201. Other alternative surfaces within drain opening 201, such as the upper face of an existing removable baffle (not shown), would also be sufficient to provide an effective sealing surface provided that magnet 208 does not align with switch 214. In this configuration, interlock device 200 acts as a stopper for the sink and, because magnet 208 is not aligned with switch 214, the batch food waste disposer is not activated.

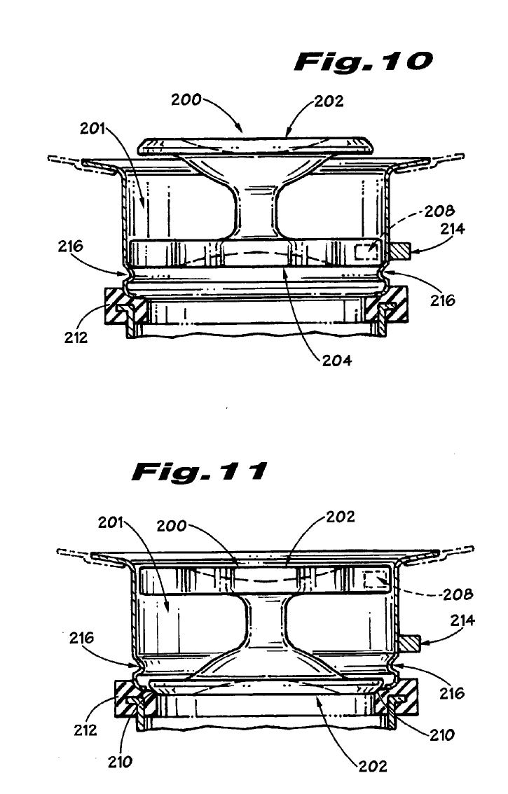

FIG. 9B and FIG. 10 illustrate the open position for interlock device 200. When the second side 204 is inserted downward into drain opening 201, the second side rests on annular ridge 216, which is preferably of a diameter between D₁ and D₂ (and hence would allow end 202, but not end 204, to pass). In this position, magnet 208 is aligned with switch 214 (i.e., switch 16 of FIGS. 1-4) located outside the sink flange, thereby activating the food waste disposer. Note that the location of annular ridge 216 provides the proper vertical alignment with switch 214. However, the interlock device 200 may seat on other surfaces, including the mounting gasket (not shown) or an existing removable baffle (not shown), provided that magnet 208 is aligned with switch 214 and water is allowed to freely flow into the disposer.

Although second end 204 is shown in this embodiment as having a “three-spoked” design, it should be apparent to one of skill in the art that other shapes could be used provided that the surface seats within drain opening 201 in such a way that the food waste disposer is activated and water is allowed to flow into the disposer. In the embodiment of FIGS. 8-11, the second side 204 has a non-circular geometric face that inherently provides spaces 220 for water to flow through drain opening 201 when seated in this configuration, and therefore water freely flows into the disposer, which is desirable during operation of the disposer. Alternatively, providing an interlock device 200 with a second end that is circular would require some form of drain openings (i.e. holes, slits) that can allow water to freely flow into the disposer when the disposer is activated.

Furthermore, although this embodiment shows a single magnet 208 located within one “spoke” on second end 204, one skilled in the art should appreciate that any number of magnets may be placed at any number of locations along the periphery of second end 204 so as to realize the advantages described herein. Another alternative embodiment of the magnet is a magnetic band 207, as shown in phantom in FIG. 8, which may be employed in conjunction with the second end 204 to eliminate the need to radially align the second end 204 with the switch 214 while still allowing water to flow through to the disposer. Note that a magnetic band 207 may be employed with a second end that is circular in geometry or non-circular in geometry as is shown in FIG. 8. A plurality of magnets along the periphery of the second end 204 provides yet another option for disposer engagement since a switching mechanism may be designed with a plurality of redundant switches that must be aligned simultaneously with a plurality of magnets in an interlock device in order to activate the disposer. Arrows may be provided either on the first or second end and on the drain opening 201 to guide the user in aligning magnet 208 with switch 214 if such alignment is necessary in a given embodiment.

Interlock device 200 is preferably constructed at least partially of a plastic material, but one skilled in the art should appreciate that any other suitable material, such as a rubber or non-magnetic metal material for example, may be used.

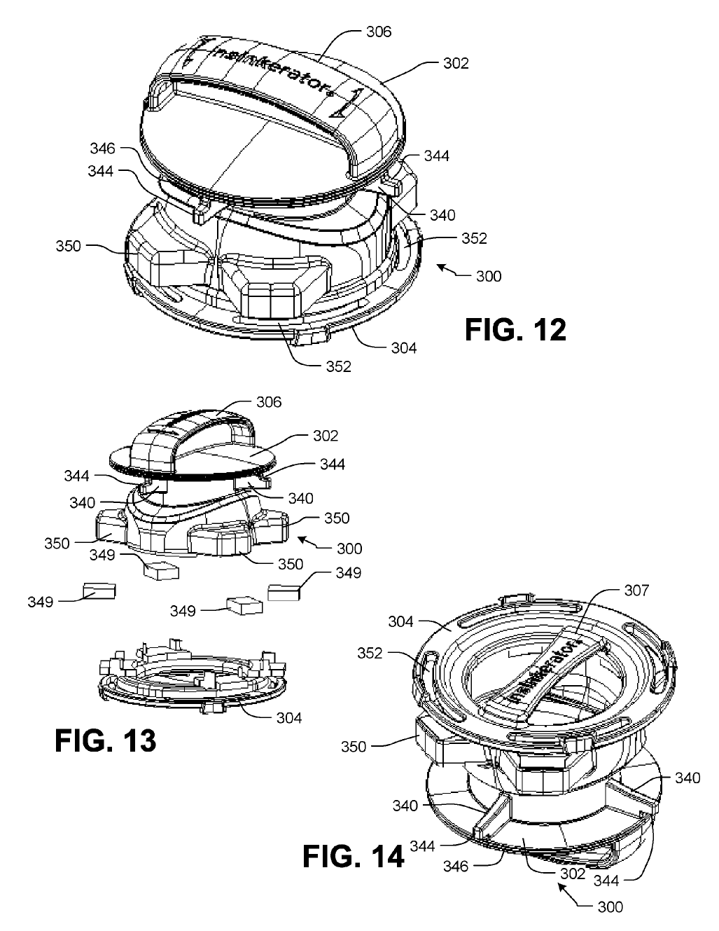

FIGS. 12-14 illustrate another embodiment of a combination interlock/stopper device 300. As with the interlock device 200, the interlock device 300 can be a one-piece unit having no movable components. It has two opposing ends: a first end 302 and a second 304. The first end 302 is the stopper end that functions to plug the drain opening when the interlock device 300 is inserted into the sink flange with the first end 302 oriented down. As with the device 200 (referring to FIG. 8), the first end 302 of the device 300 has a smaller diameter than the second end 304, allowing the first end 302 to be inserted farther into a drain opening to perform its function as a stopper. Stopping members 340 are situated near the first end 302, having at least a portion thereof 344 extending beyond the outer periphery 346 of the first end that prevent the first end 302 from being pushed out of the sink flange. To facilitate handling of the interlock device 300 by a user, handles 306, 307 are provided at the ends 302, 304.

The second end 304 is sized to be situated in the appropriate part of the drain opening to align magnets with a switching device to operate the disposer, such as the switching components 14, 16, 26 of the switch assembly 10 shown in FIGS. 1-4. Magnets 349 are situated in lobes 350 extending from the second end 304 for activating the switch to operate the food waste disposer. The exploded view of the device 300 shown in FIG. 13 shows the second end 304 removed from the device 300 to illustrate the placement of the magnets 349 in the lobes 350. When the second end 304 of the device 300 is placed into the drain opening, the interlock device 300 functions to control operation of the disposer. The second end 304 is generally circular in shape, with openings 352 defined therethrough to allow water to pass through the second end 304.

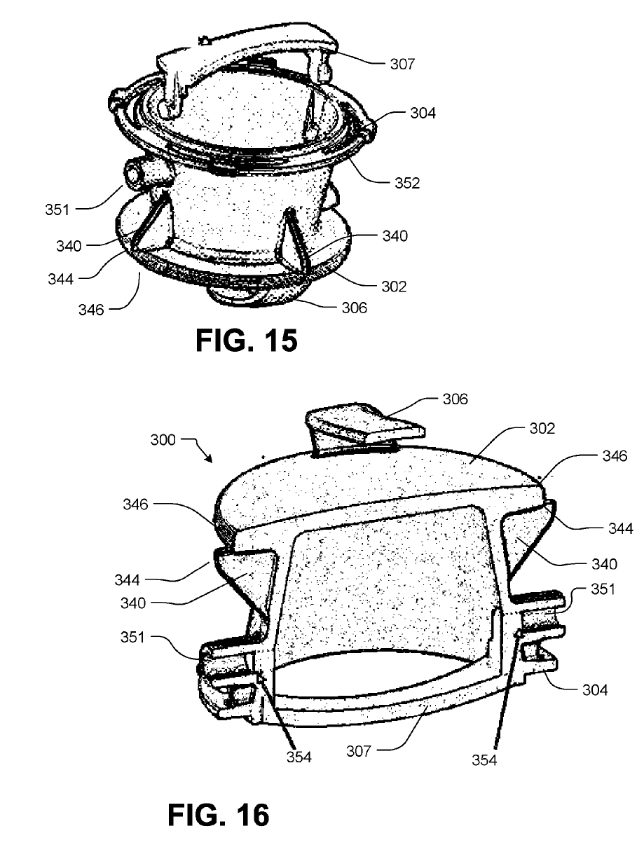

Another embodiment of an interlock device 300′ is shown in FIGS. 15-17. Handles 306 and 307 are provided at the ends 302 and 304, respectively. The handle 306 at the first end 302 is integrally formed with the first end 302. Referring back to FIG. 11, the interlock device 200 is shown with its first end 202 inserted into the drain opening to stop the drain. In this position, the second end 204 might be situated below or near the top of the drain opening. The second end 204 forms a cup-like pocket that can collect fluid or debris, resulting in the handle 206 being immersed in the fluid or debris. Further, when the second end 204 is inserted into the drain opening to operate the disposer, the handle 206 is potentially exposed to the food waste as it is being grinded by the disposer.

To prevent a user from having to grasp a handle that is immersed in fluid or debris, the second end 304 of the interlock device 300′ has a removable handle 307. FIG. 14 shows the second end 304 with the handle 307 attached thereto. The handle 307 can be removed from the second end 304 as shown in FIG. 15. The handle 307 includes projections 354 extending from opposite ends of the handle that snap into the inside portions of magnet pockets 351 to attach the handle 307 to the second end 304 as shown in FIG. 16. To remove the handle 307, the sides of the handle 307 are flexed inwardly to disengage the projections 354 from the pockets 351.

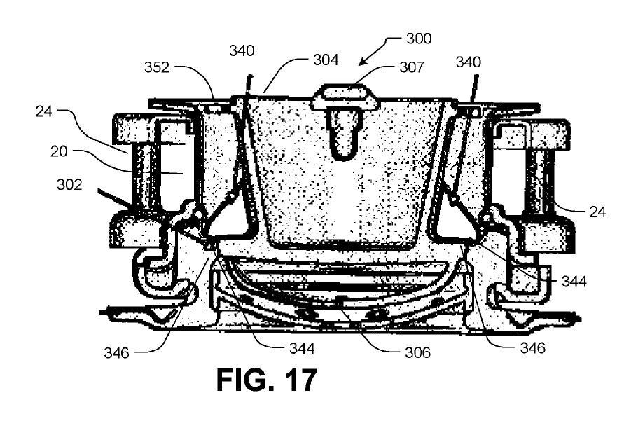

Thus, a user can attach the handle 307 to the second end 304 to insert the stopper end 302 into the drain opening, as shown in FIG. 17. The handle 307 can then be removed and the stopped sink can be filled with water or used as desired. To remove the stopper, the handle 307 is reattached to the second end 304 and the device 300 is pulled out of the drain opening. FIG. 17 further shows the function of the stop members 340, which have portions 344 extending beyond the outer periphery 346 sealing portion of the first end 302 to contact an inside ledge 342 of the drain opening. In the embodiment illustrated in FIG. 17, the ledge 342 is part of an antivibration mount system.

In other embodiments, separate pockets are provided to receive the projections 354, rather than engaging the projections 354 with magnet pockets. For example, in the embodiment shown in FIGS. 8-11, the magnet 208 is positioned directly in the second end 204. In such an embodiment, pockets may be defined in the second end for receiving projections of a removable handle.

While the invention has been described with reference to specific embodiments, it is not limited to these embodiments. The invention may be modified or varied in many ways and such modifications and variations are within the scope and spirit of the invention and are included within the scope of the following claims.

What is claimed is:

1. A combination interlock and stopper device for a food waste disposer, comprising:
a first end receivable in a drain opening to plug the drain opening, the first end defining an outer periphery;
stopping members attached to the first end and extending beyond the outer periphery for engaging a ledge of the drain opening;
a second end opposite the first end; and
a magnet attached to the second end to selectively actuate the food waste disposer when the second end is inserted into the drain opening.

2. The device of claim 1, wherein the first end defines a first effective diameter and the second end defines a second effective diameter larger than the first effective diameter.

3. The device of claim 1, wherein the first end has a first handle attached thereto.

4. The device of claim 3, wherein the first handle is integrally formed with the first end.

5. The device of claim 1, wherein the second end has a second handle attached thereto.

6. The device of claim 5, wherein the second handle is removably attached.

7. The device of claim 5, wherein the second handle defines projections extending from opposite ends thereof, the projections being receivable by corresponding pockets defined in the second end of the device.

8. The device of claim 5, wherein:
the second end defines pockets therein, the pockets having first and second portions, the first portion for receiving the magnets;
the second handle defines projections extending from opposite ends thereof; and
the projections are receivable by the second portions of the pockets.

9. The device of claim 5, wherein the second end defines openings therethrough to allow water to flow through the second end.

10. A combination interlock and stopper device for a food waste disposer, comprising:
a first end receivable in a drain opening to plug the drain opening;
a first handle attached to the first end;
a second end opposite the first end;
a magnet attached to the second end to selectively actuate the food waste disposer when the second end is inserted into the drain opening; and
a second handle removably attached to the second end.

11. The device of claim 1, wherein the first handle is integrally formed with the first end.

12. The device of claim 1, wherein the second handle defines projections extending from opposite ends thereof, the projections being receivable by corresponding pockets defined in the second end of the device.

13. The device of claim 1, wherein:
the second end defines pockets therein, the pockets having first and second portions, the first portion for receiving the magnets;
the second handle defines projections extending from opposite ends thereof; and
the projections are receivable by the second portions of the pockets.

14. The device of claim 1, wherein the first end defines a first effective diameter and the second end defines a second effective diameter larger than the first diameter.

15. The device of claim 1, wherein the second end defines openings therethrough to allow water to flow through the second end.

16. The device of claim 1, wherein the first end defines stopping members extending beyond an outer periphery of there first end for engaging a ledge of the drain opening.

17. A method for operating a food waste disposer, comprising the steps of:
inserting a first end of an interlock device into a drain opening to plug the drain opening;
attaching a handle to a second end of the interlock device;
grasping the handle and removing the interlock device from the drain opening; and
inserting the second end into the drain opening and rotating the second end to selectively actuate the food waste disposer when the second end is inserted into the drain opening.

18. The method of claim 18, wherein attaching the handle includes inserting projections defined by the handle into corresponding pockets defined in the second end.

19. The method of claim 18, further comprising removing the handle from the second end.

20. The method of claim 19, wherein removing the handle includes disengaging projections defined by the handle from pockets in the second end.
